(19) United States
(12) Patent Application Publication
(10) Pub. No.: US 2010/0198802 A1
(43) Pub. Date: Aug. 5, 2010

(54) SYSTEM AND METHOD FOR OPTIMIZING SEARCH OBJECTS SUBMITTED TO A DATA RESOURCE

(75) Inventors: Andrew P. Kraftsow, Sedona, AZ (US); Ray Lugo, JR., Old Bridge, NJ (US)

Correspondence Address: BERRY & ASSOCIATES P.C., 9229 SUNSET BOULEVARD, SUITE 630, LOS ANGELES, CA, 90069, US

(73) Assignee: RENEW DATA CORP.

(21) Appl. No.: 12/693,328

(22) Filed: Jan. 25, 2010

Related U.S. Application Data
(63) Continuation-in-part of application No. 11/449,400, filed on Jun. 7, 2006.

(51) Int. Cl. G06F 17/30

(52) U.S. Cl. 707/706; 707/765; 707/E17.074; 707/E17.108

(57) ABSTRACT

A system and methods for optimizing search objects submitted to a data resource is provided. These techniques are advantageous in reviewing vast collections of content data or documents to identify relevant data or documents from the collections. The advanced search techniques are based on query terms, which isolate relevant content data that respond to the query terms.

### PRIORITY CLAIM

This application describes a system and method that can operate independently or in conjunction with systems and methods described in pending application Ser. No. 11/449,400, filed on Jun. 7, 2006, and entitled “Methods for Enhancing Efficiency and Cost Effectiveness of First Pass Review of Documents” and pending application Ser. No. 12/025,715, filed on Feb. 4, 2008, and entitled “System and Method for Utilizing Advanced Search and Highlighting Techniques for Isolating Subsets of Relevant Content Data.” The contents of each of these applications in their entirety are incorporated herein by reference. International Applications PCT US2007/013483 (WO 2007/146107) and PCT/US2009/032990 (WO 2009/100081) also relate to the two applications referenced here and the contents of the PCT applications in their entirety are also incorporated herein by reference. This application is a continuation-in-part of and claims the benefit of pending application no. 11/449,400, filed on Jun. 7, 2006, and entitled “methods for Enhancing Efficiency and Cost Effectiveness of First Pass Review of Documents.”

### COPYRIGHT NOTICE

A portion of the disclosure of this patent document contains material that is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### FIELD OF THE INVENTION

The present invention relates to systems and methods involving techniques for review and analysis of content data (in paper or electronic form) such as a collection of documents. It should be understood that paper form must be converted and represented in electronic form (e.g., by well-known optical character recognition (OCR) techniques for capturing paper and portable document format (PDF created by Adobe Systems) form that is searchable). More particularly, the present invention relates to a system and method for utilizing advanced organizing, searching, tagging, and highlighting techniques for identifying and isolating relevant data with a high degree of confidence¹ or certainty from large quantities of content data. ¹ Definition of Confidence Level per the US Department of Justice: “The level of certainty to which an estimate can be trusted.” www.ojp.usdoj.gov/BJA/evaluation/glossary/glossary_c.htm

### BACKGROUND

In the current age of information, management of content data (e.g. documents in electronic or paper form) is a daunting task. Analysis of large amounts of content data is necessary in business for many purposes, for example, litigation, regulatory activities, due diligence studies, compliance management, investigations etc. For example, just in the context of a litigation proceeding in the United States, document discovery is an enormous endeavor and results in large expenses because documents must be carefully reviewed by skilled and talented legal personnel. This expensive exercise is undertaken both not only by the party seeking the discovery, but also by the party producing documents in response to document requests by the former.

Although review and analysis of data must still today be performed by skilled legal personnel, any efforts to automate this process of reviewing and organizing content data results in great savings. However, the automated methods that do exist today are largely unsophisticated and often yield results that are not entirely accurate. For example, the conventional methods of conducting discovery today first involve gathering up every document written or received by the named individuals during a designated time period and then having skilled legal personnel review these documents to determine if any is responsive to a specific discovery request. This approach is not only prohibitively expensive, but also time consuming. Not to mention that the burden of pursuing such conventional approaches is increasing with the increasing volumes of data that is compiled in this age of information.

In some cases, search engine technology is used to make the document review process more manageable. However, the quality and completeness of search results resulting from such conventional search engine techniques are often indefinite and therefore, unreliable. For example, one does not know whether the search engine used has indeed found every relevant document, at least not with any certainty.

The main search engine technique currently used is a keyword or a free-text search coupled with indexing of terms in the documents. A user enters a search query consisting of one or more words or phrases and the search system uncovers all of the documents that have been indexed as having one or more those words or phrases in the search query. As the search system indexes more documents that contain the specified search terms, they are revealed to the user. However, in many cases, such a search technique only marginally reduces the number of documents to be reviewed, and the large quantities of documents returned cannot be usefully examined by the user. There is absolutely no guarantee that the desired information is contained in any of the documents that are uncovered.

Furthermore, many of the documents retrieved in a standard search are typically irrelevant because these documents use the searched-for terms in a way or context different from that intended by the user. Words have multiple meanings. One dictionary, for example, lists more than 50 definitions for the word “pitch.” In ordinary usage by skilled humans, such ambiguities are not a significant problem because skilled humans effortlessly know the appropriate word for any situation. In addition, conventional search engine techniques often miss relevant content data because the missed documents do not include the search terms but rather include synonyms of the search terms. That is, the search technique fails to recognize that different words can almost mean the same thing. For example, “elderly,” “aged,” “retired,” “senior citizens,” “old people,” “golden-agers,” and other terms are used, to refer to the same group of people. A search based on only one of these terms would fail to return a document if the document used a synonym rather than the search term. Some search engines allow the user to use Boolean operators. Users could solve some of the above-mentioned problems by including enough terms in a query to disambiguate its meaning or to include the possible synonyms that might be used, but clearly this takes considerable effort.

However, unlike the familiar internet searches, where a user is primarily concerned with finding any document that contains the precise information the user is seeking, discovery in a litigation is about finding every document that contains information relevant to the subject. An internet search requires a high degree of precision, whereas the discovery process requires not only a high degree of precision, but also high recall.

Continuing with the example of discovery in litigation, search queries are typically developed with the object of finding every relevant document regardless of the specific nomenclature used in the document. This makes it necessary to develop lists of synonyms and phrases that encompass every imaginable word usage combination. In practice, the total number of documents retrieved by these queries is very large.

Methodologies that rely exclusively on technology to determine which content data in a vast collection of data is relevant to a lawsuit have not gained wide acceptance regardless of the technology used. These methodologies are often deemed unacceptable because the algorithms used by the systems to determine relevancy are incomprehensible to most parties to a law suit.

There is a dire need for improved techniques that facilitate efficient isolation of relevant content data with a high degree of certainty for purposes of reviewing and analyzing the relevant data. In addition, there is an ongoing need for improved searching, tagging, and highlighting techniques to ensure increased efficiency during such review and analysis.

### SUMMARY OF THE INVENTION

The present invention relates to a system and method for utilizing advanced searching, tagging, and highlighting techniques for identifying and isolating relevant data with a high degree of certainty from large quantities of content data (in paper or electronic form).

In accordance with one aspect, the system and methods of the present invention perform an advanced search of vast amounts of content data based on query terms, in order to retrieve a subset of responsive content data. In one exemplary embodiment, a probability of relevancy or degree of certainty is determined for a unit of content data or document in the returned subset, and the content data or document is removed from the subset if it does not reach a threshold probability of relevancy. A statistical technique can be applied to determine whether remaining documents (that is, not in the responsive documents subset) in the collection meet a predetermined acceptance level.

In accordance with yet another aspect of the invention, the system considers all content data in a thread of correspondence (for example, an e-mail) and includes it in the subset of relevant data. The system also scans the content data in the thread and automatically identifies other data of interest, for example, contained in attachments and includes that as well.

In accordance with still another aspect of the invention, the system assures greater efficiency, by taking the following steps: (a) randomly selecting a predetermined number of documents from remaining content data; (b) reviewing the randomly selected documents to determine whether the randomly selected documents include additional relevant documents; (c) if additional relevant documents are retrieved, identifying one or more specific terms in the additional content data that renders the data relevant and expanding the query terms with those specific terms, and running the search again with the expanded query terms.

In yet a further aspect of the system and methods described here, a feedback loop criteria, ensures that content data that is relevant with a high degree of certainty and probability is shown early on to human reviewers. In traditional content data review, content data that is isolated and queued up for consideration is usually ordered by custodian and chronology. Even if some other method is used, the order generally remains fixed throughout the isolating process. To accomplish this, the system and methods here use a heuristic algorithm for selecting the next content data unit or document that takes into account the disposition of the content data or documents previously seen by the reviewers. The algorithm operates in both an inclusive and an exclusive direction. Content data and documents are excluded from the isolating process if they contain any previously seen relevant language strings. To effect this, the database must be continuously updated during the isolating process to reflect the strings that human reviewers may discover. The system described here permits modification of search routines based on human input of attributes contained in content data found to be relevant. Hence, content data in a queue for consideration may be moved up. For example, attributes such as author, date, subject (if email), size, document type and social network may be used.

In yet a further aspect of the invention, instead of finding all content data relevant to an issue and with a high degree of certainty, the system can search and isolate certain key content data of particular interest (e.g. “privileged” or “hot” documents). The system and methods described here accomplish this with two steps: 1) a re-evaluation of the database unitization and 2) a recalculation of the Poisson distribution² criteria. Poisson distribution criteria demands that the relevance of object A has no impact on the relevance of object B. To isolate “hot” data content, the system considers not only the text but also the author and recipient of the text. Therefore, the system searches for privileged or “hot” documents. The system has to remove duplicate documents at a different level and then has to recalculate the formulas based on the expected density of the subject matter that is being search to determine sample size. To isolate select privileged data, the system uses precise and rigorous string identifications such as the topic in conjunction with noun, verb, or object sets. ² In probability theory and statistics, the Poisson distribution is a discrete probability distribution that expresses the probability of a number of events occurring in a fixed period of time if these events occur with a known average rate and independently of the time since the last event.

In accordance with an entirely automated aspect of the system, without human operators, the system incorporates an automatic query-builder. With this aspect human operators simply highlight the parts of the content data or document that seem relevant to an issue(s) and the software components of the system automatically formulate precise boolean queries utilizing the highlighted parts of the text. The highlighted text need not be contiguous. To construct the query, the system runs the highlighted text through a part-of-speech tagger, which eliminates various parts of speech and eliminates stop-words. The system executes some rules about the operator “within” and then builds the query. The automatic query builder aspect of the system also permits expert users to make some “AND” or “OR” decisions about non-contiguous highlights by holding down the CONTROL key while executing the highlighting function. This automatic query builder significantly reduces the need for human operators. In accordance with this aspect, users read the document, highlighting whatever language strings relate to the issues that they seek to address. The user associates each highlighted text to an issue (or multiple issues). When the users are done with this exercise, the automated query builder forms the queries, runs them in the background and bulk tags the search result documents. The system also displays a sample of randomly selected results so that the user can test the statistical certainty that the query was precise.

### BRIEF DESCRIPTION OF THE DRAWINGS

The features of the present application can be more readily understood from the following detailed description with reference to the accompanying drawings wherein:

FIG. 1 is a block diagram of a computer system or information terminal on which programs can run to implement the methods of these inventions described here.

FIG. 2 is a flow chart of an exemplary method of reviewing vast collections of content data to identify relevant content data.

FIG. 3 is a flow chart of an exemplary method for reviewing vast collections of content data to identify relevant content data.

FIG. 4 is a flow chart of a method for reviewing a collection of content data or documents to identify relevant documents from the collection, according to another exemplary embodiment.

FIG. 5 is a flow chart of a method for reviewing a collection of content data or documents to identify relevant documents from the collection, according to another exemplary embodiment.

FIG. 6 is a flow chart of a method for reviewing a collection of content data or documents to identify relevant documents from the collection, according to another exemplary embodiment.

FIGS. 7A and 7B represent a flow chart for a workflow of a process including application of some of the techniques discussed here.

FIG. 8 is a flow chart of an automated query builder feature of the present system and method directed towards a search of a collection of documents comprising text.

FIG. 9 is a flow chart of an example illustrating a database containing emails, attachments, and stand alone files from a corporate network, all which constitute the content data for review.

FIG. 10 is a flow chart of an exemplary embodiment of a “smart highlighter” feature of the present system and method.

FIG. 11 illustrates an exemplary architecture representing one embodiment of the automatic query builder.

### DETAILED DESCRIPTION

Non-limiting details of exemplary embodiments are described below, including discussions of theory and experimental simulations which are set forth to aid in an understanding of this disclosure but are not intended to, and should not be construed to limit in any way the claims which follow thereafter.

The present invention relates to systems and methods involving techniques for organization, review and analysis of content data (in paper or electronic form), such as a collection of documents. The systems and methods described here utilize advanced searching, tagging, and highlighting techniques for identifying and isolating relevant content data with a high degree of confidence³ or certainty from large quantities of content data. ³ Definition of Confidence Level per the US Department of Justice: “The level of certainty to which an estimate can be trusted.” www.ojp.usdoj.gov/BJA/evaluation/glossary/glossary_c.htm

The system search techniques used here search the content data based on language “strings.” In addition, the system uses Poisson-based mathematics to predict how much content data or how many documents would need to be reviewed before finding every relevant language string in the collection of content data. This is based on the principle that relevant language strings are distributed in content data in accordance with the theory of Poisson distribution. Moreover, the number of relevant strings in a given amount of content data or document is a function of the number of issues addressed, not a function of the size of the content data. Furthermore, the number of relevant language strings, on average, does not exceed 50 per issue regardless of the size of the collection of content data. Because the system uses Poisson-based mathematics, the system retrieves content data with relevant language strings quickly and efficiently, thereby saving unnecessary review of irrelevant data by skilled humans. Review of irrelevant data without use of this system was inevitable because the data presented was organized by custodian and chronology.

The system and techniques here additionally use Poisson-based statistical sampling to prove that isolation of relevant content data is accomplished with a stated degree of certainty. In other words, that all content data with relevant language strings is retrieved. The system uses a defined set of rules and a Boolean search engine to find every occurrence of relevant language strings. By using a bulk tagging mechanism, and applying specific tagging rules and naming conventions, the system marks the relevant documents in a manner that is auditable. This way of tagging yields two benefits-1) a user knows exactly why each document was tagged as relevant; and 2) a user can “undo” the tagging if a language string is re-classified as non-relevant at a later date.

In some instances, documents are delivered to an assembly line of skilled humans to review documents in batches (the most common situation). Identifying relevant language strings in prior batches significantly decreases the time to review documents in future batches.

Full citations for a number of publications may be found immediately preceding the claims. The disclosures of these publications are hereby incorporated by reference into this application in order to more fully describe the state of the art as of the date of the methods and apparatuses described and claimed herein. In order to facilitate an understanding of the discussion which follows one may refer to the publications for certain frequently occurring terms which are used herein.

Although not required, the invention will be described in the general context of computer-executable instructions, such as program modules. Generally, program modules include routines, programs, objects, scripts, components, data structures, etc. that performs particular tasks or implement particular abstract data types. Moreover, those skilled in the art will appreciate that the invention may be practiced with any number of computer system configurations including, but not limited to, distributed computing environments where tasks are performed by remote processing devices that are linked through a communications network. In a distributed computing environment, program modules may be located in both local and remote memory storage devices. The present invention may also be practiced in personal computers (PCs), hand-held devices, multiprocessor systems, microprocessor-based or programmable consumer electronics, network PCs, minicomputers, mainframe computers, and the like.

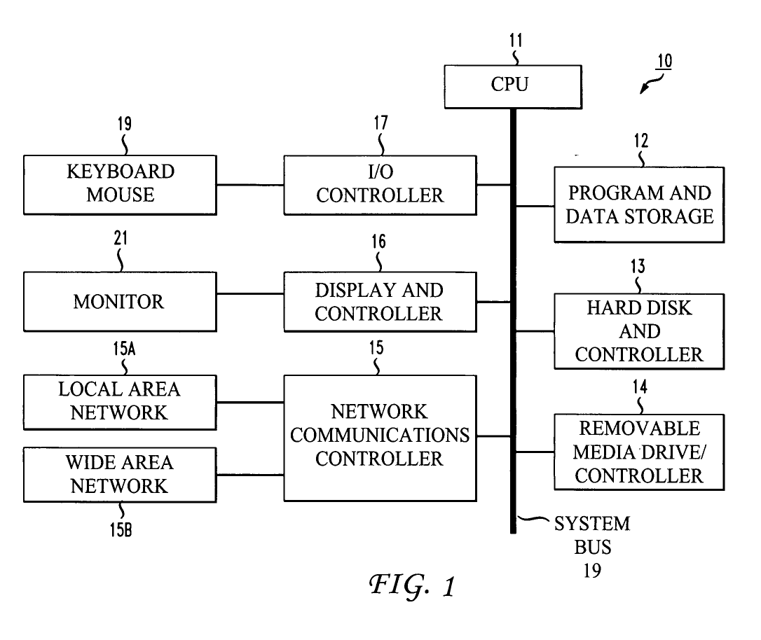

FIG. 1 is a schematic diagram of an exemplary computing environment in which the present invention may be implemented. The present invention may be implemented within a general purpose computing device 10 in the form of a conventional computing system. One or more computer programs may be included in the implementation of the system and method described in this application. The computer programs may be stored in a machine-readable program storage device or medium and/or transmitted via a computer network or other transmission medium.

Computer 10 includes CPU 11, program and data storage 12, hard disk (and controller) 13, removable media drive (and controller) 14, network communications controller 15 (for communications through a wired or wireless network (LAN or WAN, see 15A and 15B), display (and controller) 16 and I/O controller 17, all of which are connected through system bus 19. Although the exemplary environment described herein employs a hard disk (e.g. a removable magnetic disk or a removable optical disk), it should be appreciated by those skilled in the art that other types of computer readable media which can store data that is accessible by a computer, such as magnetic cassettes, flash memory cards, digital video disks, Bernoulli cartridges, random access memories (Rams), read only memories (ROMs), and the like, may also be used in the exemplary operating environment.

A number of program modules may be stored on the hard disk 13, magnetic disk, and optical disk, ROM or RAM, including an operating system, one or more application programs, other program modules, and program data. A user may enter commands and information into the computing system 10 through input devices such as a keyboard (shown at 19), mouse (shown 19) and pointing devices. Other input devices (not shown) may include a microphone, joystick, game pad, satellite dish, scanner, or the like. These and other input devices are often connected to the central processing unit 11 through a serial port interface that is coupled to the system bus, but may be connected by other interfaces, such as a parallel port, game port or a universal serial bus (USB). A monitor 21 or other type of display device is also connected to the system bus via an interface, such as a video adapter. In addition to the monitor 21, computers typically include other peripheral output devices (not shown), such as speakers and printers. The program modules may be practiced using any computer languages including C, C++, assembly language, and the like.

Some examples of the methods implemented for reviewing a collection of content data or documents to identify relevant documents from the collection in accordance with exemplary embodiments of the present invention are described below.

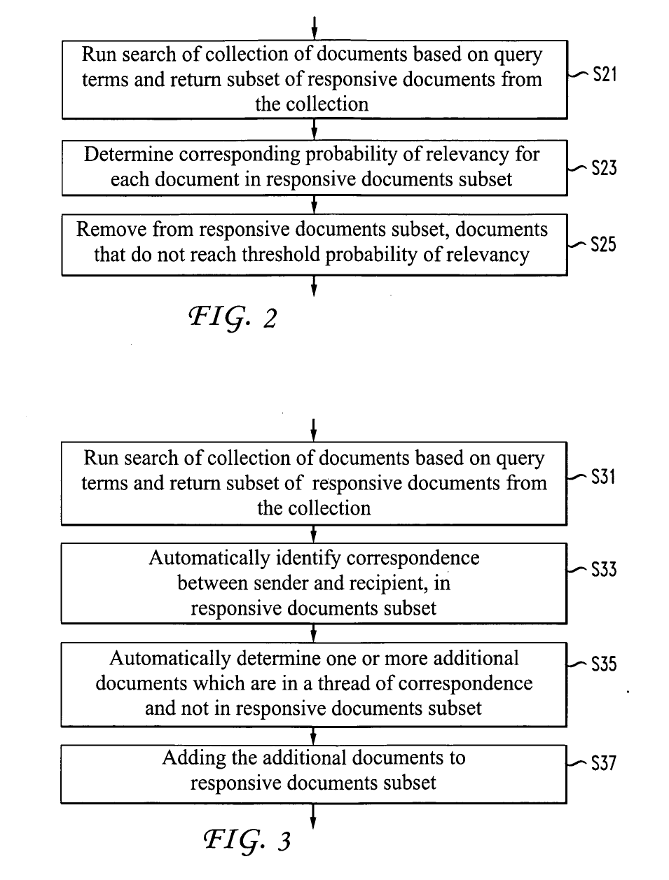

In one example (FIG. 2), a method for reviewing a content data or a vast collection of documents to identify relevant documents from the collection can entail a) running a search of the collection of documents based on a plurality of query terms and b) retrieving a subset of responsive documents from the collection (step S21), 3) determining a corresponding probability of relevancy for each document in the responsive documents subset (step S23) and 4) removing from the responsive documents subset, documents that do not reach a threshold probability of relevancy (step S25).

The search techniques discussed in this disclosure are preferably automated as much as possible. Therefore, the search is preferably applied through a search engine. The search can include a concept search, and the concept search is applied through a concept search engine. Such searches and other automated steps or actions can be coordinated through appropriate programming, as would be appreciated by one skilled in the art.

The probability of relevancy of a document can be scaled according to a measure of obscurity of the search terms found in the document. The method can further comprise a) randomly selecting a predetermined amount of content data or a sample number of documents from the remaining content data found to be not relevant. and b) determining whether the randomly selected documents include additional relevant documents, and in addition, optionally, identifying one or more specific terms in the additional relevant documents that render the documents relevant, expanding the query terms with the specific terms, and re-running at least the search with the expanded query terms. In the event the randomly selected content data or documents include one or more additional relevant items of content data, the query terms can be expanded and the search run again with the expanded query terms. The method additionally comprises comparing a ratio of the additional relevant documents and the randomly selected documents to a predetermined acceptance level, to determine whether to apply a refined set of query terms.

The method further comprises the step of selecting two or more search terms, identifying synonyms of the search terms, and forming the query terms based on the search terms and synonyms.

The method further comprises the step of identifying a correspondence between a sender and a recipient, in the responsive documents subset, automatically determining one or more additional documents which are in a thread of the correspondence, the additional documents not being in the responsive documents subset, and adding the additional documents to the responsive documents subset. The term “correspondence” is used herein to refer to a written or electronic communication (for example, letter, memo, email, text message, etc.) between a sender and a recipient, and optionally with copies going to one or more copy recipients.

The method further comprises the step of determining whether any of the documents in the responsive documents subset includes an attachment that is not in the responsive documents subset, and adding the attachment to the responsive documents subset. The method further comprises the step of applying a statistical technique (for example, zero-defect testing) to determine whether remaining documents not in the responsive documents set meet a predetermined acceptance level.

In one embodiment, the search includes (a) a Boolean search of the collection of documents based on the plurality of query terms, the Boolean search returning a first subset of responsive documents from the collection, and (b) a second search by applying a recall query based on the plurality of query terms to remaining ones of the collection of documents which were not returned by the Boolean search, the second search returning a second subset of responsive documents in the collection, and wherein the responsive documents subset is constituted by the first and second subsets. The first Boolean search may apply a measurable precision query based on the plurality of query terms. The method can optionally further include automatically tagging each document in the first subset with a precision tag, reviewing the document bearing the precision tag to determine whether the document is properly tagged with the precision tag, and determining whether to narrow the precision query and rerun the Boolean search with the narrowed query terms. The method can optionally further comprise automatically tagging each document in the second subset with a recall tag, reviewing the document bearing the recall tag to determine whether the document is properly tagged with the recall tag, and determining whether to narrow the recall query and rerun the second search with the narrowed query terms. The method can optionally further include reviewing the first and second subsets to determine whether to modify the query terms and rerun the Boolean search and second search with modified query terms.

In another example (FIG. 3), a method for reviewing a collection of documents to identify relevant documents from the collection includes running a search of the collection of documents, based on a plurality of query terms, the search returning a subset of responsive documents in the collection (step S31), automatically identifying a correspondence between a sender and a recipient, in the responsive documents subset (step S33), automatically determining one or more additional documents which are in a thread of the correspondence, the additional documents not being in the responsive documents subset (step S35), and adding the additional documents to the responsive documents subset (step S37).

Some additional features which are optional include the following.

The method can further comprise determining for each document in the responsive documents subset, a corresponding probability of relevancy, and removing from the responsive documents subset documents that do not reach a threshold probability of relevancy. The probability of relevancy of a document can be scaled according to a measure of obscurity of the search terms found in the document.

The system and method further comprises applying a statistical technique to determine whether a remaining subset of the collection of documents not in the responsive documents subset meets a predetermined acceptance level.

The method additionally comprises the steps of a) randomly selecting a predetermined number of documents from a remainder of the collection of documents not in the responsive documents subset, b) determining whether the randomly selected documents include additional relevant documents, c) identifying one or more specific terms in the additional relevant documents that render the documents relevant, d) expanding the query terms with the specific terms, and e) running the search again with the expanded query terms.

The method further includes the steps of a) randomly selecting a predetermined number of content data or documents from a remainder of the collection of documents not in the responsive documents subset, b) determining whether the randomly selected documents include additional relevant documents, c) comparing a ratio of the additional relevant documents and the randomly selected documents to a predetermined acceptance level, and expanding the query terms and d) running the search with the expanded query terms, if the ratio does not meet the predetermined acceptance level.

The method further comprises the step of selecting two or more search terms, identifying synonyms of the search terms, and forming the query terms based on the search terms and synonyms.

The method additionally includes the step of determining whether any of the responsive content data or documents in the responsive documents subset includes an attachment that is not in the subset, and adding the attachment to the subset.

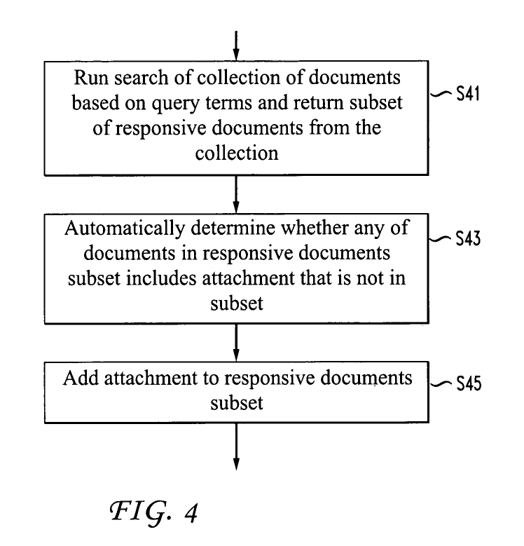

In another example (FIG. 4), a method for reviewing a collection of documents to identify relevant documents from the collection can comprise running a search of the collection of documents, based on a plurality of query terms, the search returning a subset of responsive documents in the collection (step S41), automatically determining whether any of the responsive documents in the responsive documents subset includes an attachment that is not in the subset (step S43), and adding the attachment to the responsive documents subset (step S45).

Some additional features which are optional include the following.

The method further comprises determining for each document in the responsive documents subset, a corresponding probability of relevancy, and removing from the responsive documents subset documents that do not reach a threshold probability of relevancy. The probability of relevancy of a document is preferably scaled according to a measure of obscurity of the search terms found in the document.

The method additionally comprises applying a statistical technique to determine whether a remaining subset of the collection of documents not in the responsive documents subset meets a predetermined acceptance level.

The method further includes randomly selecting a predetermined number of documents from a remainder of the collection of documents not in the responsive documents subset, determining whether the randomly selected documents include additional relevant documents, identifying one or more specific terms in the additional responsive documents that render the documents relevant, expanding the query terms with the specific terms, running the search again with the expanded query terms.

The method further includes selecting two or more search terms, identifying synonyms of the search terms, and forming the query terms based on the search terms and synonyms.

The method further comprises identifying a correspondence between a sender and a recipient, in the responsive documents subset, automatically determining one or more additional documents which are in a thread of the correspondence, the additional documents not being in the responsive documents subset, and adding the additional documents to the responsive documents subset.

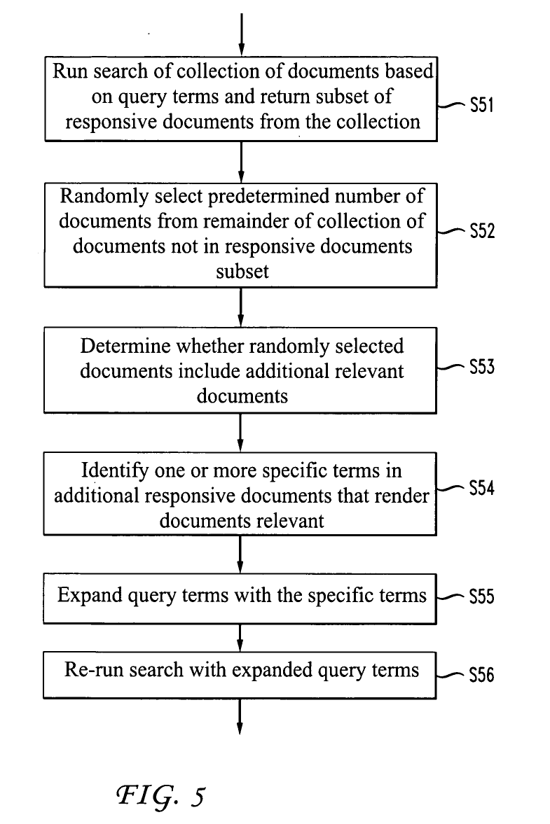

In another example (FIG. 5), a method for reviewing a collection of documents to identify relevant documents from the collection comprises running a search of the collection of documents, based on a plurality of query terms, the search returning a subset of responsive documents from the collection (step S51), randomly selecting a predetermined number of documents from a remainder of the collection of documents not in the responsive documents subset (step S52), determining whether the randomly selected documents include additional relevant documents (step S53), identifying one or more specific terms in the additional responsive documents that render the documents relevant (step S54), expanding the query terms with the specific terms (step S55), and re-running the search with the expanded query terms (step S56).

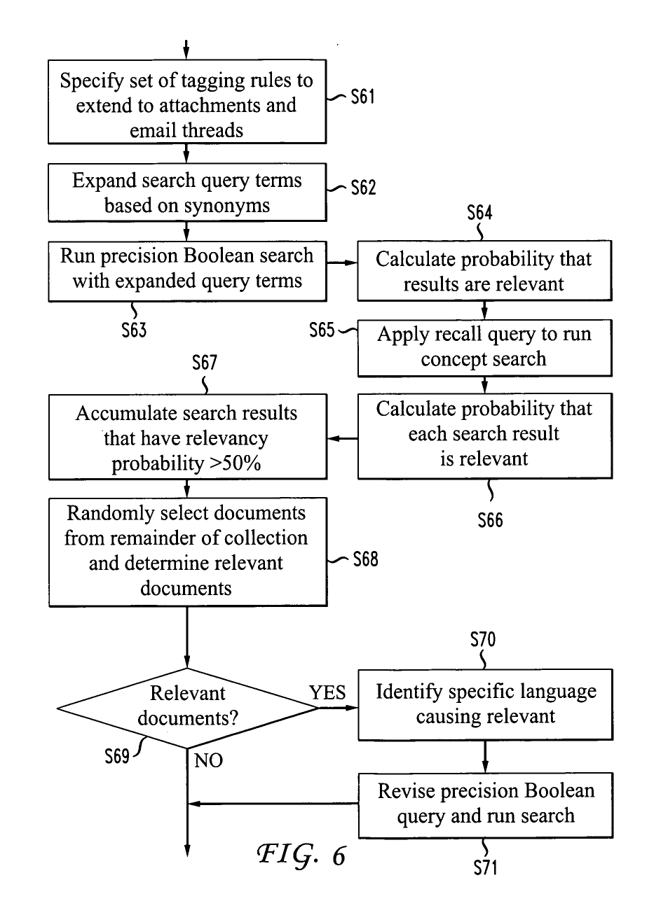

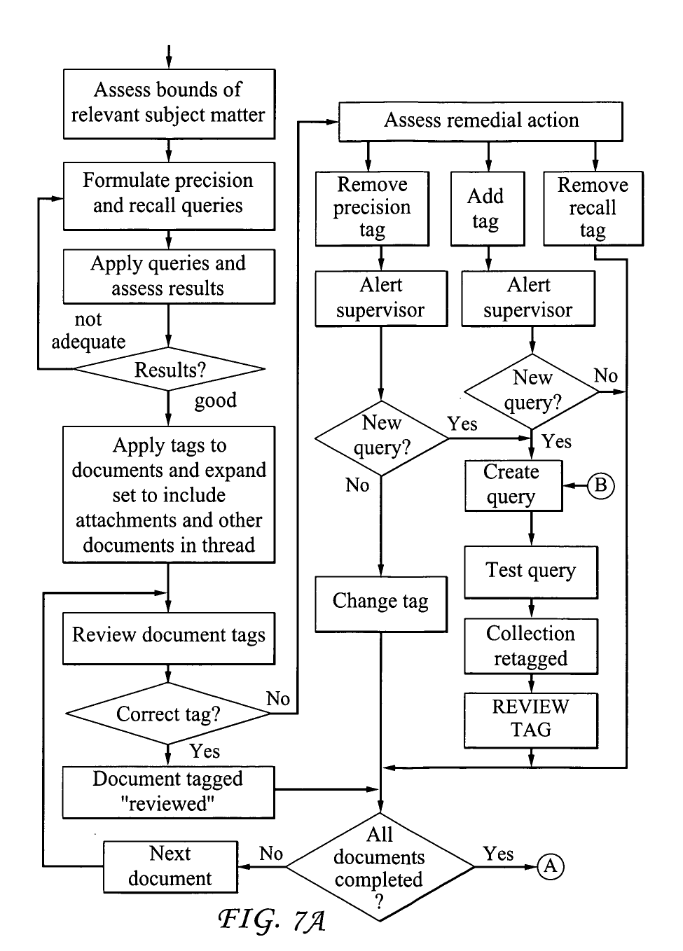

In another example (FIG. 6), a method for reviewing a collection of documents to identify relevant documents from the collection can comprise specifying a set of tagging rules to extend query results to include attachments and email threads (step S61), expanding search query terms based on synonyms (step S62), running a precision Boolean search of the collection of documents, based on two or more search terms and returning a first subset of potentially relevant documents in the collection (step S63), calculating the probability that the results of each Boolean query are relevant by multiplying the probability of relevancy of each search term, where those individual probabilities are determined using an algorithm constructed from the proportion of relevant synonyms for each search term (step S64), applying a recall query based on the two or more search terms to run a second concept search of remaining ones of the collection of documents which were not returned by the first Boolean search, the second search returning a second subset of potentially relevant documents in the collection (step S65), calculating the probability that each search result in the recall query is relevant to a given topic based upon an ordering of the concept search results by relevance to the topic by vector analysis (step S66), accumulating all search results that have a relevancy probability of greater than 50% into a subset of the collection (step S67), randomly selecting a predetermined number of documents from the remaining subset of the collection and determining whether the randomly selected documents include additional relevant documents (step S68), if additional relevant documents are found (step S69, yes), identifying the specific language that causes relevancy, and expanding that language into a set of queries (step S70), constructing and running precision Boolean queries of the entire document collection above (step S71).

The following discussions of theory and exemplary embodiments are set forth to aid in an understanding of the subject matter of this disclosure but are not intended to, and should not be construed as, limiting in any way the invention as set forth in the claims which follow thereafter.

As discussed above, one of the problems with using conventional search engine techniques in culling a collection of content data or documents is that such techniques do not meet the requirements of recall and precision.

However, by using statistical sampling techniques it is possible to state with a defined degree of confidence the percentage of relevant documents that may have been missed. Assuming the percentage missed is set low enough (1%) and the confidence level is set high enough (99%), this statistical approach to identifying relevant documents would likely satisfy most judges in most jurisdictions. The problem then becomes how to select a subset of the document collection that is likely to contain all responsive documents. Failure to select accurate content data in the first place results in an endless cycle of statistical testing.

The probability that results from a simple Boolean search (word search) is relevant to a given topic and is directly related to the probability that the query terms themselves are relevant, i.e. that those terms are used within a relevant definition or context in the documents. Similarly, the likelihood that a complex Boolean query will return relevant documents is a function of the probability that the query terms themselves are relevant.

For example, the documents collected for review in today's lawsuits contain an enormous amount of email. It has been found that corporate email is not at all restricted to “business as such” usage. In fact, it is hard to distinguish between personal and business email accounts based on subject matter. As a consequence, even though a particular word may have a particular meaning within an industry, the occurrence of that word in an email found on a company server does not guarantee that is it has been used in association with its “business” definition.

An exemplary method for determining a probability of relevancy to a defined context is discussed below.

The following factors can be used to determine the probability that a word has been used in the defined context within a document: (1) the number of possible definitions of the word as compared to the number of relevant definitions; and (2) the relative obscurity of relevant definitions as compared to other definitions.

Calculation of the first factor is straightforward. If a word has five potential definitions (as determined by a credible dictionary) and if one of those definitions is responsive, then the basic probability that word is used responsively in any document retrieved during discovery is 20% (⅕). This calculation assumes, however, that all definitions are equally common, that they are all equally likely to be chosen by a writer describing the subject matter. Of course, that is generally not the case; some definitions are more “obscure” than others meaning that users are less likely to chose the word to impart that meaning. Thus, a measure of obscurity must be factored into the probability calculation.

A social networking approach can be taken to measure obscurity. The following method is consistent with the procedure generally used in the legal field currently for constructing query lists: (i) a list of potential query terms (keywords) is developed by the attorney team; (ii) for each word, a corresponding list of synonyms is created using a thesaurus; (iii) social network is drawn (using software) between all synonyms and keywords; (iv) a count of the number of ties at each node in the network is taken (each word is a node); (v) an obscurity factor is determined as the ratio between the number of ties at any word node and the greatest number of ties at any word node, or alternatively their respective z scores; and (vi) this obscurity factor is applied to the definitional probability calculated above.

The method described above calculates the probability that a given word is used in a relevant manner in a document. Boolean queries usually consist of multiple words, and thus a method of calculating the query terms interacting with each other is required.

The simplest complex queries consist of query terms separated by the Boolean operators AND and/or OR. For queries separated by an AND operator, the individual probabilities of each word in the query are multiplied together to yield the probability that the complex query will return responsive results. For query terms separated by an OR operator, the probability of the query yielding relevant results is equal to the probability of the lowest ranked search term in the query string.

Query words strung together within quotation marks are typically treated as a single phrase in Boolean engines (i.e. they are treated as if the string is one word). A document is returned as a result if and only if the entire phrase exists within the document. For purposes of calculating probability, the phrase is translated to its closest synonym and the probability of that word is assigned to the phrase. Moreover, since a phrase generally has a defined part of speech (noun, verb, adjective, etc.), when calculating probability one considers only the total number of possible definitions for that part of speech, thereby reducing the denominator of the equation and increasing the probability of a responsive result.

Complex Boolean queries can take the form of “A within X words B”, where A and B are query terms and X is the number of words in separating them in a document which is usually a small number. The purpose of this type of query, called a proximity query, is to define the terms in relation to one another. This increases the probability that the words will be used responsively. The probability that a proximity query will return responsive documents equals the probability of the highest query term in the query will be responsive.

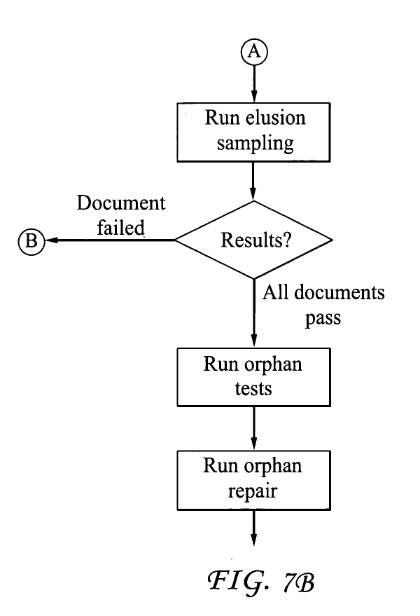

A workflow of a process including application of some of the techniques discussed herein, according to one example, is shown exemplarily in FIGS. 7A and 7B.

One aspect of the present invention is a method and system for optimizing search objects to be submitted to a data resource. The search objects may comprise a variety of items, for example, words or phrases, graphics or images, special coding such as software code, sounds, or any other object capable of being used to search now known or hereafter discovered. The method includes the steps of receiving the objects or the intent of a to-be-performed search, analyzing the objects or intent of the search, comparing the objects or intent of the search to known contexts that would render such a search unmanageable or less optimized, eliminating certain objects or intents of the search or otherwise designating these objects or intents as non-optimal objects or intents, constructing a search query suitable for a data resource containing one or more of the objects or intents of the to be performed search, and submitting the optimized search objects to the data resource.

In a preferred embodiment, the search objects are text terms, such as words and phrases, to be used to search a data resource. Data resources include any resource capable of being searched such as, for example, a collection of documents as discussed above or databases containing a variety of information. In a preferred embodiment, the data resources are stored in a digital manner. In other embodiments, the data resource is a commercial database. In a preferred embodiment, the commercial databases are directed towards storage of litigation documents and materials. In one such exemplary embodiment, the commercial litigation database is a Concordance® database. Additional embodiments include data resources contained on the Internet regardless of storage method. Exemplary embodiments include Google®, Yahoo®, or similar search engine websites. Although the following embodiments are directed towards text information, one of ordinary skill in the art would understand searching non-textual information as within the scope of the description.

The method and system for optimizing search objects to be submitted to a data resource may take the form of computer executable instructions stored in a memory that when executed on a processor performs the steps of assembling search terms and submitting those search terms to a data resource. In some embodiments, the computer executable instructions are encapsulated and abstracted so that other software and hardware resources are able to take advantage of the benefits of the method and system through the use of an application programming interface (API), database extensions, or similar interfaces.

In another embodiment, the method and system are abstracted as a plugin, add-on, extension, widget or other similar constructs (collectively referred to as a “plugin” or “plug-ins” in this specification) to be used by well-known web browsers such as Firefox®, Internet Explorer®, Safari®, Opera®, or other web browsers now known or hereafter discovered. In yet another embodiment, the plugin is used by “traditional” software applications such as Adobe Acrobat®, Microsoft Word®, or the like.

One such exemplary embodiment of the method and system of optimizing search objects to be submitted to a data resource is an automated query builder. An automated query builder enables one to abstract the details of query construction, language, social context and the like from an operator or software application. For example, in a litigation context, an operator may understand that all references to a particular subject need to be found in a collection of documents. However, the operator may not understand, for example, BOOLEAN search parameters, or in some cases, fully understand the nuances of the language in which the documents are kept. An advantage of the present invention is that an operator need only find one or more understandable phrases or passages within the collection of documents. An automated query builder will be able to optimize the search query based on known language, grammar, and colloquial rules.

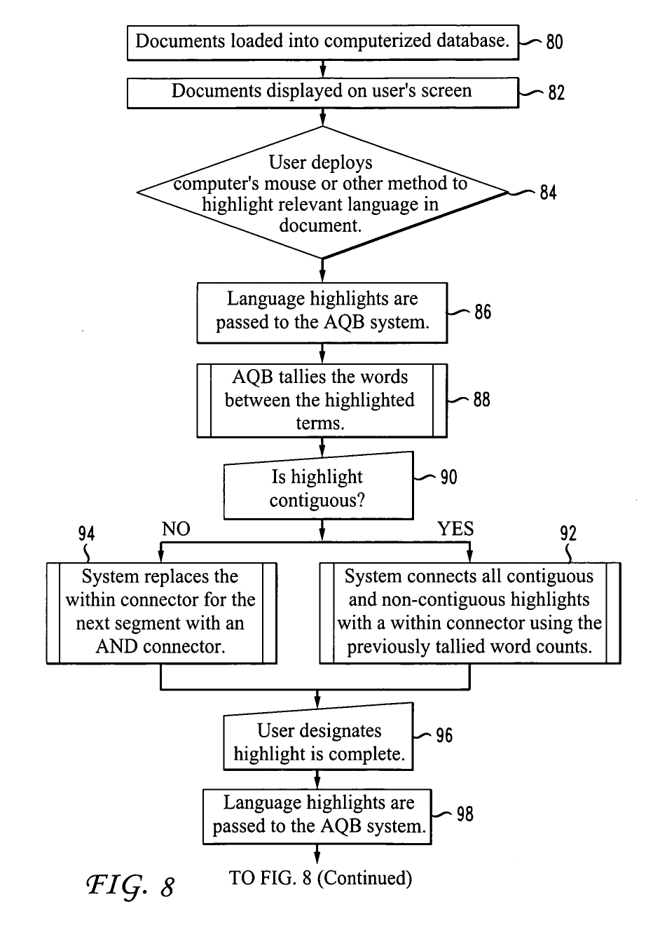

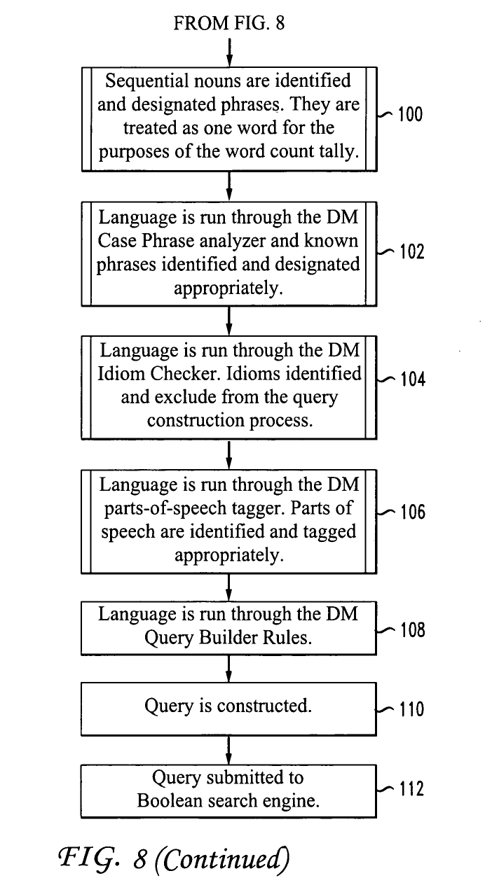

FIG. 8 is a flow chart of the automated query builder feature of the present system and method directed towards a search of a collection of documents comprising text. This aspect includes operations whereby content data or documents are loaded into a database, illustrated by block 80. The content data or documents may be displayed on the user's screen (shown at 82). The user may use a computer mouse or other method to highlight the relevant text in the content data or document, as illustrated by reference numeral 84. The highlighted text is forwarded to the automatic query builder routine in the system (see block 86).

The automatic query builder routine may reside in various places within the system. In some embodiments, the highlighting routines may reside on a user's computer and the query building routines may reside on a remote server. In some embodiments, the query building routines reside in or are delivered by a computing cloud or similar architectures such as software as a service (SaaS), utility computing, web applications, or centrally managed hosting schemes. In other embodiments, the highlighting and query building routines reside solely on a user's computer. In some such embodiments, the automatic query builder may be limited to the data resources that exist on the user's computer and is used as a stand-alone application.

As illustrated by block 88, the automatic query builder routine tallies the words between the highlighted terms. The system ensures that the highlighting is contiguous (see 90). If it is, the system connects all contiguous and non-contiguous highlights within a connector using the previously tallied word counts (see block 92). If it is not, the system replaces the within connector for the next segment with an AND connector (see 94). Following these operations, the user designates that the highlighting is complete (see 96). The highlighted section is passed to the automatic query builder, at 98.

In some embodiments, the automated query builder may limit or combine the number of search terms submitted to the data resource. For example, due to hardware resource concerns, a particular database interface may limit the number of search terms to be submitted to fifty words. So that the query may be optimized, the automated query builder will limit, combine or count the words highlighted in a particular text to those words deemed most beneficial to the particular search. In some embodiments, the automated query builder accomplishes this task via a word count tally. In an exemplary embodiment, the automated query builder identifies sequential nouns and designated phrases. The sequential nouns and designated phrases are treated as a single word for the purpose of the word count tally (indicated by reference numeral 100).

Additionally, the automated query builder identifies known phrases that may not be beneficial for an optimized search of the data resource. In one embodiment, the highlighted text is submitted to a case phrase analyzer and such text matching known phrases are appropriately designated (see 102). In some embodiments, text matching is achieved by comparing the phrases to a list of known phrases. In many embodiments, the list is a generic list of known phrases in a particular language. In other embodiments, the list is specifically compiled based on the parameters of a project the user is currently working on. For example, a document reviewer in the litigation context may know for a particular case in litigation and a collection of documents resulting from that litigation that a particular phrase takes on a particular meaning. In this case, this phrase is added to the list to be matched against during case phrase analysis. In some embodiments, the designated text is eliminated from any resulting search query. In other embodiments, the designated text is counted as one word in a word count tally.

The automated query builder also identifies objects that may be peculiar to a particular culture, language or context whereby the meanings of the objects together possess a different meaning than the individual objects. In embodiments where the data resource includes language(s), the automated query builder may analyze the search objects or intent for idioms peculiar to a particular language. Idioms are expressions of language where the meaning of a phrase is not understandable from the individual meanings of the words in the phrase or elements of the words. For example, the idiom “cat got your tongue” is used in English speech to mean one who is unusually quiet. It generally is not used to state that a cat actually has possession of someone's tongue. Another example is “that movie is for the birds,” which generally is intended to mean that the movie was uninteresting or meaningless. When used, the idiom generally does not mean that the movie was made for a bird's viewing pleasure. Eliminating idioms from or counting matched idioms as one word in a word count tally in a particular search query (unless an idiom is the particular object of the search) results in a more meaningful and optimized search of a particular collection of documents. In some embodiments, a list of idioms for multiple languages may be employed. In the preferred embodiment described above, the highlighted text is subjected to an idiom checker (see 104) where idioms are identified and counted as one word in a word count tally in the query construction process. In other embodiments, the text subject to an idiom checker is excluded from the query construction process. In one embodiment, the proper list to use for the idiom checker may be selected by an operator. In another embodiment, the automated query builder may determine the proper list(s) to use by analyzing characteristics of the language within the document collection. For example, if the document collection includes emails between a person who writes in English and a person who writes in Japanese, the automated query builder may employ both an English and Japanese idiom list.

The automated query builder also analyzes the structure or usage of the search objects so as identify those elements within the structure or usage of the objects or data resource that may be superfluous to the searching task. In embodiments involving language and text, the automated query builder analyzes the structure and grammar of the language used to identify the parts-of-speech. In the preferred embodiment described above, the highlighted text is submitted to a parts-of-speech tagger routine (106) that analyzes the structure of the language, identifies the parts-of-speech and appropriately tags them.

Table 1 is one example of some parts of speech in the English language identified in an exemplary parts-of-speech tagger routine.

| Part of Speech | Description | Enabled | Secondary Enabled |
|---|---|---|---|
| coordinating | “and”, “but”, “nor”, “or”, “yet”, plus, minus, less, | 0 | 0 |
| conjunction | times (multiplication), over (division). Also “for” | | |
| | (because) and “so” (i.e., “so that”). | | |
| cardinal number | | 1 | 1 |
| determiner | Articles including “a”, “an”, “every”, “no”, “the”, | 0 | 0 |
| | “another”, “any”, “some”, “those”. | | |
| existential there | Unstressed “there” that triggers inversion of the | 0 | 0 |
| | inflected verb and the logical subject; “There | | |
| | was a party in progress”. | | |
| word in another language | | 0 | 0 |
| preposition or subordinating | | 0 | 0 |
| conjunction | | | |
| adjective | Hyphenated compounds that are used as | 0 | 1 |
| | modifiers; happy-go-lucky. | | |
| adjective - | Adjectives with the comparative ending “-er” and | 0 | 1 |
| comparative | a comparative meaning. Sometimes “more” and | | |
| | “less”. | | |
| adjective - superlative | Adjectives with the superlative ending “-est” | 1 | 1 |
| | (and “worst”). Sometimes “most” and “least”. | | |
| list item marker | Numbers and letters used as identifiers of items | 0 | 0 |
| | in a list. | | |
| modal | All verbs that don't take an “-s” ending in the | 0 | 0 |
| | third person singular present: “can”, “could”, | | |
| | “dare”, “may”, “might”, “must”, “ought”, “shall”, | | |
| | “should”, “will”, “would”. | | |
| noun | singular or mass | 1 | 1 |
| proper noun - singular | All words in names usually are capitalized but | 1 | 1 |
| | titles might not be. | | |
| proper noun - plural | All words in names usually are capitalized but | 1 | 1 |
| | titles might not be. | | |
| noun - plural | n/a | 1 | 1 |
| proper noun - singular | n/a | 1 | 1 |
| proper noun - plural | n/a | 1 | 1 |
| predeterminer | Determiner like elements preceding an article or | 0 | 0 |
| | possessive pronoun; “*all* his marbles”, “*quite* | | |
| | a mess”. | | |
| possessive ending | Nouns ending in “'s” or “'”. | 1 | 1 |
| personal pronoun | | 1 | 1 |
| possessive pronoun | Probably possessive pronoun, such as “my”, | 1 | 1 |
| | “your”, “his”, “his”, “its”, “one's”, “our”, and | | |
| | “their”. | | |
| adverb | Most words ending in “-ly”. Also “quite”, “too”, | 0 | 0 |
| | “very”, “enough”, “indeed”, “not”, “-n??u0099t”, | | |
| | and “never”. | | |
| adverb - comparative | adverbs ending with “-er” with a comparative | 0 | 0 |
| | meaning. | | |
| adverb - superlative | | 0 | 0 |
| particle | Mostly monosyllabic words that also double as | 0 | 0 |
| | directional adverbs. | | |
| start state marker | (used internally) | 0 | 0 |
| symbol | Technical symbols or expressions that aren't | 0 | 0 |
| | English words. | | |
| literal to | | 0 | 0 |
| interjection | Such as “my”, “oh”, “please”, “uh”, “well”, “yes”. | 0 | 0 |
| verb - past tense | Includes conditional form of the verb “to be”; “If I | 1 | 1 |
| | *were* rich . . . ”. | | |
| verb - gerund or | n/a | 1 | 1 |
| present participle | | | |
| verb - past participle | n/a | 1 | 1 |
| verb - non-3rd person | n/a | 1 | 1 |
| singular present | | | |
| verb - base form | Subsumes imperatives, infinitives and | 1 | 1 |
| | subjunctives. | | |
| verb - 3rd person | n/a | 1 | 1 |
| singular present | | | |
| wh-determiner | n/a | 0 | 0 |
| possessive wh-pronoun | Includes “whose” | 0 | 0 |
| wh-pronoun | Includes “what”, “who”, and “whom”. | 0 | 0 |
| wh-adverb | Includes “how”, “where”, “why”. Includes “when” | 0 | 0 |
| | when used in a temporal sense. | | |
| literal colon | n/a | 0 | 0 |
| literal comma | n/a | 0 | 0 |
| literal dollar sign | n/a | 0 | 0 |
| literal double-dash | n/a | 0 | 0 |
| literal left parenthesis | n/a | 0 | 0 |
| literal period | n/a | 0 | 0 |
| literal pound sign | n/a | 0 | 0 |
| literal right | n/a | 0 | 0 |
| parenthesis | | | |
| literal single quote or | n/a | 0 | 0 |
| apostrophe | | | |
| linking verbs | grow, feel, look, smell, taste .appears, seem, | 1 | if this verb appears |
| | become, remain, keep, resemble, sound, stay, | | keep the following |
| | turn, prove | | adjective or adverb |
| Form of verb ‘to be’ | If verb form is form of verb ‘to be,’ exclude verb | 0 | if this verb appears |
| | | | keep the following |
| | | | adjective or adverb |

In Table 1, a word that is designated as a particular part of speech from the table is excluded from the search query if a zero appears in the enabled or secondary enabled column. If a ‘1 ’ appears in the table, that word is included in the search query. The secondary enabled column is consulted when the word is included in a phrase that does not include a verb. For example, in the phrase “Fred is very angry,” the phrase contains a personal pronoun (Fred), a form of the verb to be (is), and two adverbs (very angry). The automated query builder would exclude the words “is, very” in accordance with the Table 1. The word “Fred” and “angry” are kept for further processing in the search query. One special example is the case of linking verbs. In a phrase, if a linking verb is present the adjective or adverb (which otherwise may be excluded) that follows a linking verb is kept for further processing in the search query. For example, in the phrase “Bill feels angry,” the words “Bill” and “angry” will be kept for further processing in the search query.

The automated query builder also constructs the now analyzed search objects or intents into a well-formed query according to requirements of the data resource. In the preferred embodiment described above, the text is subjected to the system query builder rules (shown at 108) and a search query is constructed (see step 110).

Once a query is constructed, the automated query builder submits the query to the data resource. In some embodiments, the data resource is a Boolean search engine at 112.

As stated above, the method and system for optimizing search objects to be submitted to a data resource may take the form of computer executable instructions stored in a memory. The computer executable instructions may take the form of any suitable programming language. In some embodiments, the computer instructions are written in the JAVA® programming language. One such exemplary embodiment is provided below that demonstrates the instructions that when executed on a processor performs the method described above:

// Remove idioms
clause = removeIdioms(clause);
if(clause != null && !clause.equals(“”) &&
textNoIdiomsBuilder.length( ) > 0){
textNoIdiomsBuilder.append(connector);
}
textNoIdiomsBuilder.append(clause);
// Replace special chars
clause = removeSpecialChars(clause);
if(clause != null && !clause.equals(“”) &&
textNoSpecialCharsBuilder.length( ) > 0) {
textNoSpecialCharsBuilder.append(connector);
}
textNoSpecialCharsBuilder.append(clause);
// Replace hyphens
clause = replaceHyphensAndUnderscrore(clause);
if(clause != null && !clause.equals(“”) &&
textHyphensReplacedBuilder.length( ) > 0) {
textHyphensReplacedBuilder.append(connector);
}
textHyphensReplacedBuilder.append(clause);
// Add case phrases & synonyms
clause = addCasePhrases(clause);
if(clause != null && !clause.equals(“”) &&
textPhrasesAddedBuilder.length( ) > 0) {
textPhrasesAddedBuilder.append(connector);
}
textPhrasesAddedBuilder.append(clause);
logger.debug(“AFTER addCasePhrases = ”+clause);
// Remove stop words
clause = removeStopWords(clause);
if(clause != null && !clause.equals(“”) &&
textNoStopWordsBuilder.length( ) > 0) {
textNoStopWordsBuilder.append(connector);
}
textNoStopWordsBuilder.append(clause);
logger.debug(“AFTER removeStopWords = ”+clause);
// Parts of Speech tag
String posTagged = posTagByPhrase(clause);
if(clause != null && !clause.equals(“”) &&
textPosTaggedBuilder.length( ) > 0) {
textPosTaggedBuilder.append(connector);
}
textPosTaggedBuilder.append(posTagged);
logger.debug(“AFTER PosTagged = ”+posTagged);
// Remove disabled Parts of Speech
int clauseLength = clause.length( );
clause = removePosByPhrase(clause);
if(clause != null && !clause.equals(“”) &&
textPosRemovedBuilder.length( ) > 0) {
textPosRemovedBuilder.append(connector);
} else if(clause != null && clause.equals(“”)) {
continue;
}
textPosRemovedBuilder.append(clause);
logger.debug(“AFTER removeDisabledPos = ‘“+clause+”’”);
©2008 Renew Data Corp. All Rights Reserved.

Although the automated query builder has been described in terms of text documents, it should be noted that the objects subjected to the automated query builder need not be specific to text and may take multiple forms such as audio, video, or graphics, alone or in combination with text. In these embodiments, the automated query builder is configured to properly identify and analyze the submitted content and eliminate those elements not suited for an optimized search of a data resource. For example, one may wish to search a collection of documents for a picture of an employee of an organization for a workman's compensation litigation case. The intent of the search may be to identify instances of an employee functioning “normally.” In this example, the automated query builder may eliminate instances where the employee was represented as a caricature or cartoon. Other instances to eliminate may be situations that are known not to add any information to a search such as “staged” pictures, for example, family pictures, or pictures taken and used specifically for a company website. Furthermore, the automated query builder may be able to combine different content in constructing a query. For example, a search for an audio imprint and a picture of a person could be constructed.

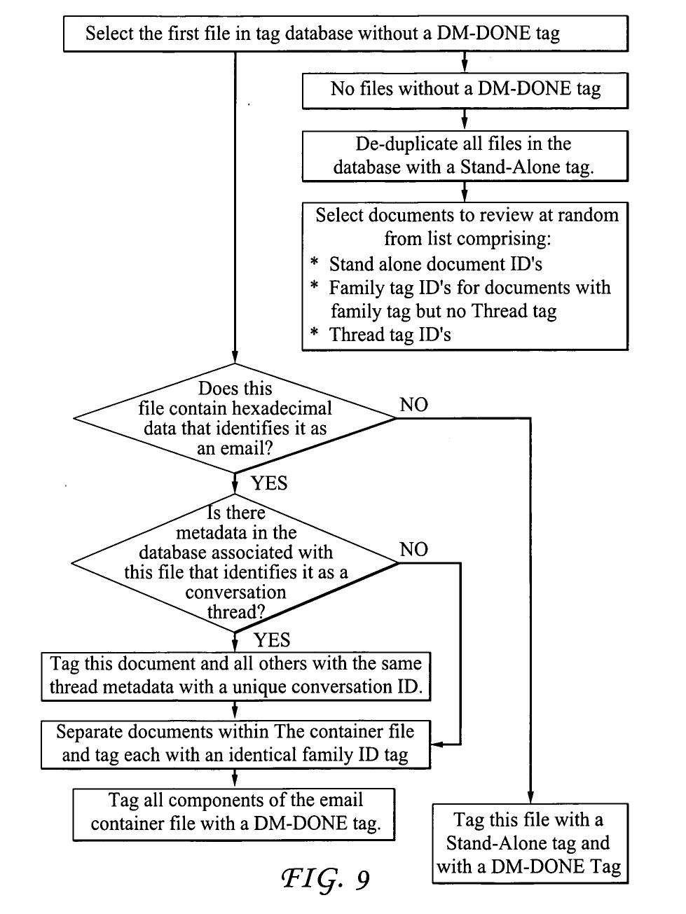

FIG. 9 illustrates the way related content data is identified and ultimately tagged. For example, in a database of a corporate network containing emails, attachments and stand alone files, the system considers all content data in a thread of correspondence (for example, an e-mail) and includes it in the subset of relevant data. The system also scans the content data in the thread and automatically identifies other data of interest, for example, contained in attachments and includes that as well.

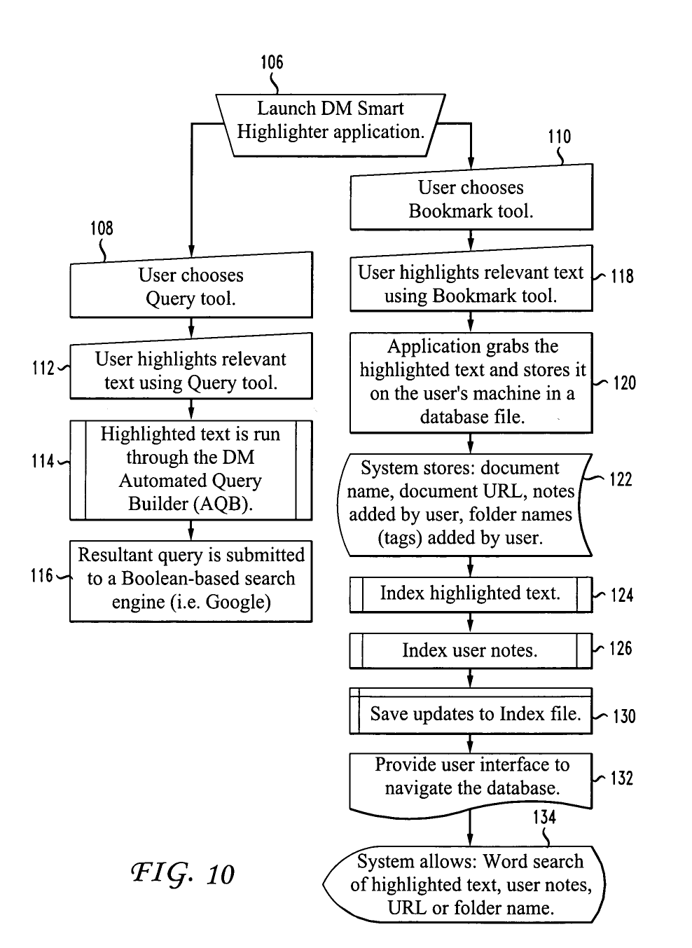

FIG. 10 illustrates a flow chart representing the steps used in a “smart highlighter” routine of the system. This routine is launched (106) allowing the user to select either a query tool (see 108) or a bookmark tool (see 110). In the event the user chooses a query tool, the user can use it to highlight any text of interest (see 112). The highlighted text is run through an automated query builder (see 114) and the resulting query is submitted to the Boolean-based search engine (116).

In the event the user chooses the bookmark tool, the user highlights any text of interest with the bookmark tool (see 118). The system takes the highlighted text and stores it on the user's computer machine in a database file (see 120). At operation 122, the system stores the document name, document URL, any notes added by the user, folder names (tags) added by the user. Following this, the system indexes the highlighted text (124), the user notes (126) and saves updates to the index file (130). The user may navigate the database via a user interface (132) as the system allows a word search of the highlighted text, user notes, URL or folder name etc. (134).

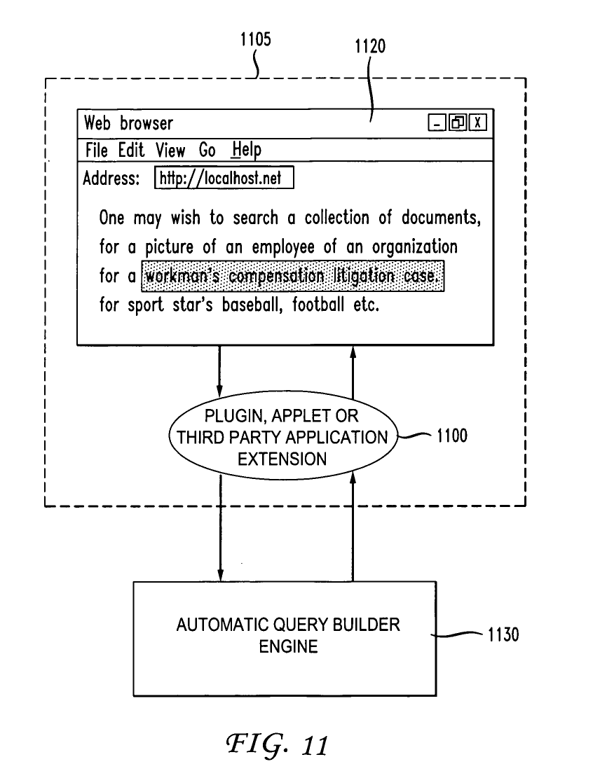

FIG. 11 illustrates an exemplary architecture representing one embodiment of the automatic query builder. For example, in one embodiment, the method and system are abstracted as a browser plugin, applet, or third party application extension or the like 1100 and resides on the user's computer 1105. When a user is browsing a data resource using a web browser or other application 1120, the user highlights or otherwise indicates in the web browser 1120 text of interest to submit for a search. The user then indicates through the web browser 1120 that such highlighted text is to be submitted to the automatic query builder engine 1130 through the web browser plugin, applet or third party application extension 1100. The text is processed in accordance with the above-described method of the automatic query builder and then returned to the web browser plugin, applet, or third party application extension 1100. The plugin, applet, or third party application 1100 then returns the result to the web browser 1120. In some embodiments, the automatic query builder result may be returned directly to a search box or other area designated for entering search terms. In other embodiments, the results may be returned to an area where the user may need to perform an additional operation, for example, copy and paste, into the appropriate area of the target application. Once the processed text is returned the user may then submit the query to the data resource.

The specific embodiments and examples described herein are illustrative, and many variations can be introduced on these embodiments and examples without departing from the spirit of the disclosure or from the scope of the appended claims. For example, features of different illustrative embodiments and examples may be combined with each other and/or substituted for each other within the scope of this disclosure and appended claims.

The following references are incorporated by reference:
Herbert L. Roitblat, “Electronic Data Are Increasingly Important To Successful Litigation” (November 2004).
Herbert L. Roitblat, “Document Retrieval” (2005).
“The Sedona Principles: Best Practices Recommendations & Principles for Addressing Electronic Document Production” (July 2005 Version).

What is claimed is:

1. A computer-implemented method of optimizing search objects in a query comprising the steps of:
receiving a plurality of terms from an application;
creating a first set of terms by identifying one or more known terms within the plurality of terms and removing the matching terms;
creating a second set of terms from the first set of terms by identifying one or more of the plurality of terms in the first set of terms with one or more lists of idioms, and removing the matching terms from the first set;
creating a third set of terms from the second set of terms by identifying one or more of the plurality of terms in the second set of terms with one or more lists of parts of speech; and
constructing a search query from the third set of terms particular to the application.

2. The method of claim 1, wherein the search query is constructed as a Boolean query.

3. The method of claim 1, further comprising the step of submitting the search query to a search engine.

4. The method of claim 1, wherein the plurality of terms received from an application is received through an application programming interface.

5. The method of claim 1, wherein the plurality of terms from an application are received through a web browser.

6. The method of claim 1, wherein the one or more lists of parts of speech comprise lists from different languages.

7. The method of claim 1, wherein the one or more lists of idioms comprise lists from different languages.

8. A system for optimizing search objects in a query comprising:
a processor coupled to a bus;
a first memory coupled to the bus comprising computer executable instructions that when executed by the processor receive a plurality of terms from an application and creating a first set of terms by identifying one or more known terms within the plurality of terms and removing the matching terms;
a second memory coupled to the bus comprising computer executable instructions that when executed by the processor create a second set of terms from the first set of terms by identifying one or more of the plurality of terms in the first set of terms with one or more lists of idioms, and removing the matching terms from the first set;
a third memory comprising computer executable instructions that when executed by the processor create a third set of terms from the second set of terms by identifying one or more of the plurality of terms in the second set of terms with one or more lists of parts of speech; and
a fourth memory comprising computer executable instructions that when executed by the processor construct a search query from the third set of terms particular to the application.

9. The system of claim 8, wherein the search query is constructed as a Boolean query.

10. The system of claim 8, wherein the fourth memory computer executable instructions further comprise instructions for submitting the search query to a search engine.

11. The system of claim 8, wherein the plurality of terms received from an application is received through an application programming interface.

12. The system of claim 8, wherein the plurality of terms from an application are received through a web browser.

13. The system of claim 8, wherein the one or more lists of parts of speech comprise lists from different languages.

14. The system of claim 8, wherein the one or more lists of idioms comprise lists from different languages.
